(19) United States
(12) Patent Application Publication
(10) Pub. No.: US 2026/0310791 A1
(43) Pub. Date: Oct. 8, 2026

(54) SECURITY RISK SCENARIO LIBRARY GENERATION

(71) Applicant: NVIDIA Corporation, Santa Clara, CA (US)

(72) Inventor: Phani Bhushan Avadhanam, San Diego, CA (US)

(21) Appl. No.: 19/171,820

(22) Filed: Apr. 7, 2025

(51) Int. Cl. G06F 21/57

(52) U.S. Cl. CPC G06F 21/577; G06F 2221/034

(57) ABSTRACT

Devices, systems, and techniques for assessing and managing security risk scenarios associated with an artificial intelligence (AI) model executed by a primary computing system. The techniques include generating, based on a set of security-related data associated with an AI model, a library comprising a set of identified ai security risk scenarios associated with the AI model. The techniques include classifying, based on a set of AI model criteria, a first identified security risk scenario of the set of identified security risk scenarios into a first category of a set of categories to generate a first classified security risk scenario. The techniques include causing a simulated security attack associated with the computing system to be created based on the first classified security risk scenario.

### TECHNICAL FIELD

At least one embodiment pertains to assessing and managing network security risks associated with artificial intelligence models executed by a primary computing system. For example, at least one embodiment pertains to a primary computing system employing a risk assessment system to identify security attack scenarios and risks associated with an artificial intelligence model.

### BACKGROUND

Computing systems frequently ingest data from various sources, which is then stored and shared with downstream users. Data that is received from a third-party source may expose the recipient computer system to potentially malicious files, such as objects that may be infected with malware, viruses, ransomware, trojan horses, and the like.

In particular, artificial intelligence (AI) models (e.g., language models such as large language models (LLMs), small language models (SLMs), vision language models (VLMs), and multimodal language models (MMLMs)) may be received and ingested by an application of a computing system associated with an organization (i.e., a recipient application). Disadvantageously, many AI and LLM models can be manipulated and abused by a bad actor to expose the ingesting computing system to security attacks. In such cases, AI/LLM models can include attack vectors intended to cause a security breach in the recipient computing system and related application(s). Furthermore, such attacks perpetrated by a malicious AI/LLM model expose not only the recipient application to risks, but also expose one or more downstream users of the application to potential malware infection on local user devices.

Defense systems associated with the ingesting computing system are frequently unable to recognize a security threat associated with AI/LLM models. Due to this inability to identify potential attacks inherent to incoming AI/LLM models, computing systems are vulnerable to unrecognized and yet-to-be-identified attacks.

### BRIEF DESCRIPTION OF DRAWINGS

FIG. 1 is a block diagram of an example security risk scenario identification system associated with one or more primary computing systems, in accordance with at least one embodiment;

FIG. 2 depicts an example data structure representing a security risk scenario library generated by processing logic of a security risk scenario identification system, according to at least one embodiment;

FIG. 3 illustrates an example simulation engine of a security risk scenario identification system configured to perform a security risk simulation associated with a target artificial intelligence model of a primary computing system, according to at least one embodiment;

FIG. 4 is a flow diagram of an example method related to generating and managing a security risk scenario library including security risk scenarios associated with one or more artificial intelligence models for use by one or more applications executed by a primary computing system, in accordance with at least one embodiment;

FIG. 5A is a block diagram of an example generative language model system suitable for use in implementing some embodiments of the present disclosure;

FIG. 5B is a block diagram of an example generative language model that includes a transformer encoder-decoder suitable for use in implementing some embodiments of the present disclosure;

FIG. 5C is a block diagram of an example generative language model that includes a decoder-only transformer architecture suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

A wide range of applications ingest and store data associated with an AI model. The applications further share that data with one or more downstream users. Frequently, the use of AI models by a primary computing system can expose that system to one or more security risk scenarios. Frequently, these security risk scenarios are unknown to the primary computing system. In such cases, the primary computing system may execute one or more AI models with no knowledge or understanding as to the underlying security risk scenarios that may be associated with those AI models. These security risk scenarios represent a significant threat to the primary computing system and further expose other applications executed by the primary computing system and downstream users to potentially malicious files (e.g., objects that may be infected with malware, viruses, ransomware, trojan horses, and more). In particular, ingested AI models received from an untrusted third party source may represent one or more security risk scenarios that are unknown or unidentified by the primary computing system. Furthermore, primary computing systems lack a proactive, reliable, and automated way of identifying security risk scenarios in a trackable and manageable manner to enable the detection of security issues for the lifecycle of an AI model. For example, primary computing systems lack security protection measures capable of generating and managing a collection of identified security risk scenarios that can be used to understanding the risks associated with an AI model prior to ingesting and training the AI model.

Aspects of the present disclosure address the aforementioned problems and other technological challenges related to protecting a primary computing system (e.g., computing system hosting applications, services, underlying infrastructure, etc.) from security risks associated with ingesting one or more files implementing an AI model. In some embodiments, the primary computing system employs a security risk scenario identification system which generates and manages a data store or library including identified security risk scenarios associated with one or more AI models that may be ingested and executed by the primary computing system from an untrusted source (e.g., a third-party source).

According to embodiments, the security risk scenario identification system aggregates (e.g., receives, collects, extracts, scrapes, etc.) AI model security-related data (herein “AI security data”) from one or more third-party sources (e.g., AI security research papers, common vulnerabilities and exposures (CVE) databases, AI -specific vulnerability databases (e.g., AI Incident Database), technology forums, etc.). The system analyzes the AI security data (e.g., data relating to one or more security attacks associated with an AI model) to identify one or more security risk scenarios associated with one or more AI models (herein referred to as “AI security risk scenarios”). For example, the library generator 102 may employ aggregation (e.g., web scraping) of data from AI security data sources 10, including databases, forums, code repositories, and threat intelligence feeds. In an embodiment, the security risk scenario identification system employs one or more natural language processing (NLP) models to identify a context associated with security incidents identified in the AI security data to identify and define the AI security risk scenarios. Example AI security risk scenarios include untrusted data deserialization, object reference handing vulnerabilities, unauthorized code execution, shell command execution, sensitive file access, AI model reverse-engineering attacks, memory allocation attacks, CPU/GPU resource exhaustion, resource leakage, thread-based attacks, inferring of sensitive information, extraction of AI model parameters or training data.

In an embodiment, the security risk scenario identification system maintains a data store or library including information associated with identified AI security risk scenarios (herein the “security risk scenario library”). According to embodiments, the security risk scenario identification system uses the set of security-related data to generate or populate the security risk scenario library including a set of identified security risk scenarios associated with one or more AI models. In an embodiment, the security risk scenario identification system may classify each identified AI security risk scenario of the set of identified security risk scenarios into a corresponding category of a set of categories to generate a set of classified security risk scenarios. Example AI security risk scenario categories include a malicious behavior category, a resource exhaustion category, a timing attack category, etc.

In an embodiment, the security risk scenario identification system may use AI model-specific criteria to classify one or more of the identified security risk scenarios. In an embodiment, the security risk scenario library may include a set of records, where each record includes information associated with a classified security risk scenario (e.g., an identified security risk scenario and the corresponding category determined by the security risk scenario identification system). The system continually reviews AI security data collected from one or more sources to dynamically augment, update, and refine the records in the security risk scenario library associated with previously identified AI security risk scenarios (e.g., based on the latest security trends and incidents) and newly identified AI security risk scenarios. This enables the security risk scenario identification system to maintain updated records in the security risk scenario library to ensure the security risk scenario records remain current and comprehensive.

The security risk scenario identification system generates a simulated security attack associated with the computing system based on one or more identified AI security risk scenarios. In an embodiment, the security risk scenario identification system identifies an AI model that is to be executed by the primary computing system and uses the one or more identified security risk scenarios associated with the AI model to generate a simulated security attack for application to the primary computing system. In an embodiment, the security risk scenario identification system executes one or more adversarial machine learning models (AMLs) to a identify attack vectors based on the one or more identified AI security risk scenarios to apply to the primary computing system. In an embodiment, the security risk scenario identification system employs a rule-based sub-system to identify one or more known AI model vulnerabilities (e.g., prompt injection, data poisoning). In an embodiment, the security risk scenario identification system uses a generative AI model (e.g., a machine learning model including one or more neural networks) to generate one or more attack vectors or scenarios based on the one or more identified security risk scenarios associated with an AI model that is to be deployed by the primary computing system.

In an embodiment, the security risk scenario identification system tracks the one or more responses by the primary computing system to the one or more simulated attack vectors. In an embodiment, based on the one or more response, the security risk scenario identification system executes one or more remedial actions associated with the computing system. For example, the security risk scenario identification system may expose the primary computing system to a simulated security attack and identify one or more responses by the computing system to that simulated security attack. The system may then determine or more remedial actions relating to the primary computing system in view of the responses to the simulated security attack.

According to embodiments, the security risk scenario identification system performs predictive modeling based on predictive analytics to predict potential AI security risk scenarios associated with one or more AI models. The security risk scenario identification system may use the AI security risk scenario predictions to generate, update, change, or modify one or more preemptive remedial actions (e.g., security risk scenario mitigation operations or workflows).

Advantageously, the security risk scenario identification system populates and manages the library of identified security risk scenarios associated with one or more AI models that are deployed or may be deployed on a primary computing system. The library may be used to identify vulnerabilities of the primary computing system to the one or more security risk scenarios. This enables the execution of one or more remedial actions to preemptively protect the primary computing system against the identified security risk scenarios.

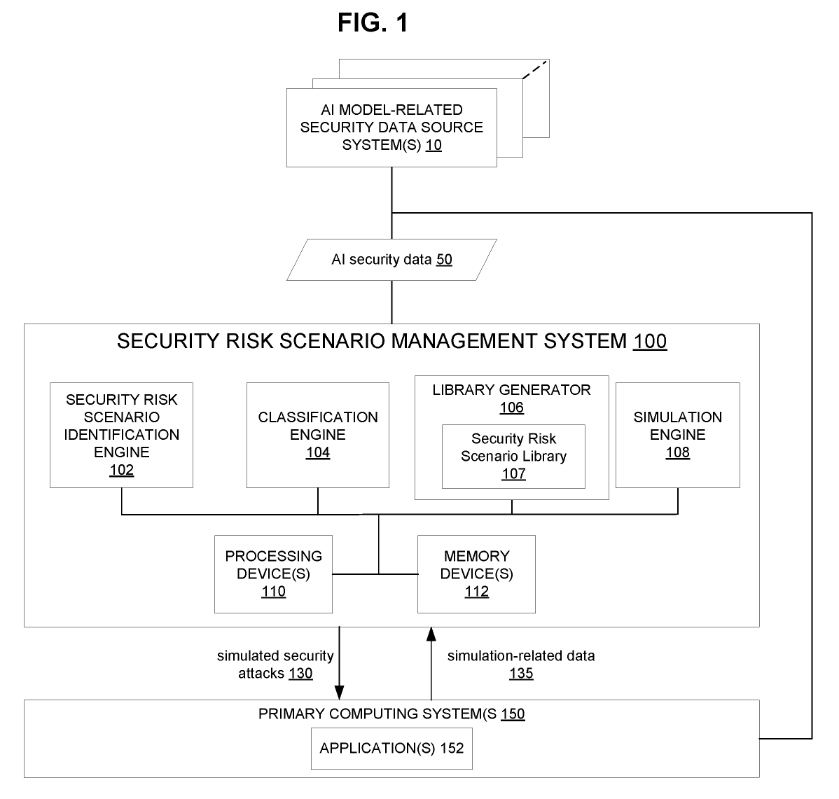

FIG. 1 is a block diagram of an example security risk scenario management system 100 configured to identify and manage security risk scenarios associated with the execution of one or more AI models consumed by one or more applications 152 executed by one or more primary computing systems 150, according to one or more embodiments. According to an embodiment, the security risk scenario management system 100 aggregates AI model security-related data 50 (herein “AI security data”) from one or more AI model-related security data source systems 10 (herein “security data source”). Example security data sources 10 include AI security research papers, common vulnerabilities and exposures (CVE) databases, technology forums, etc. In an embodiment, the AI security data 50 may be received, retrieved, downloaded, etc. by the s security risk scenario management system 100 for performing the security risk scenario identification and management, as described in detail.

According to embodiments, the security risk scenario management system 100 includes control logic (e.g., a security risk scenario identification engine 102, a classification engine 104, and a library generator 106, and a simulation engine 108) configured to identify and manage the AI-model related security risk scenarios. According to embodiments, the security risk scenario management system 100 includes one or more processing devices 110 configured to execute instructions stored in one or more memory devices 112, the instructions for performing the operations and steps associated with the control logic of the security risk scenario management system 100, described in detail herein.

According to embodiments, the one or more processing device 110 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. According to embodiments, the one or more processing devices 110 can also be one or more special-purpose processing devices such as an application specific integrated circuit (ASIC), a field programmable gate array (FPGA), a digital signal processor (DSP), network processor, or the like.

According to embodiments, the one or more memory devices 112 includes an embedded memory configured to store instructions for performing various processes, operations, logic flows, and routines that control operation of the security risk scenario management system 100. According to embodiments, the one or more memory devices can include a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage system, which communicate with each other via a bus.

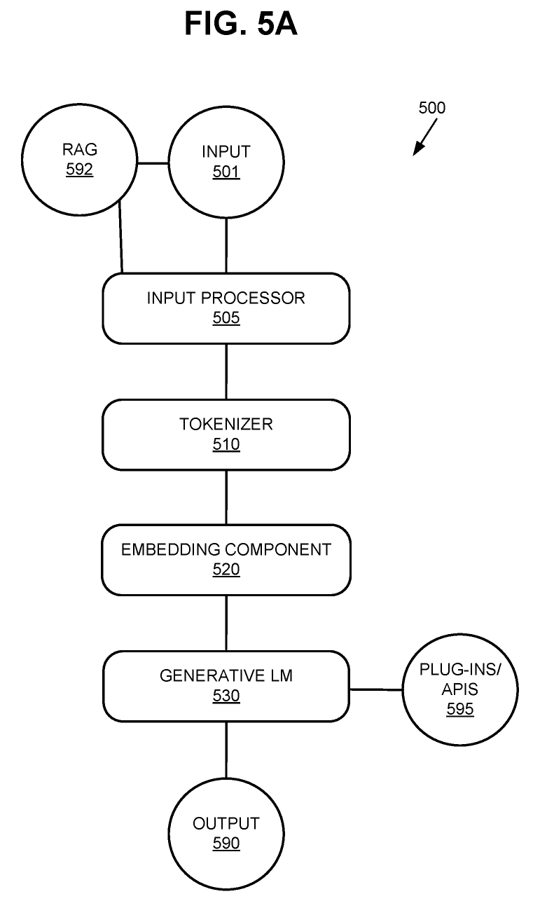

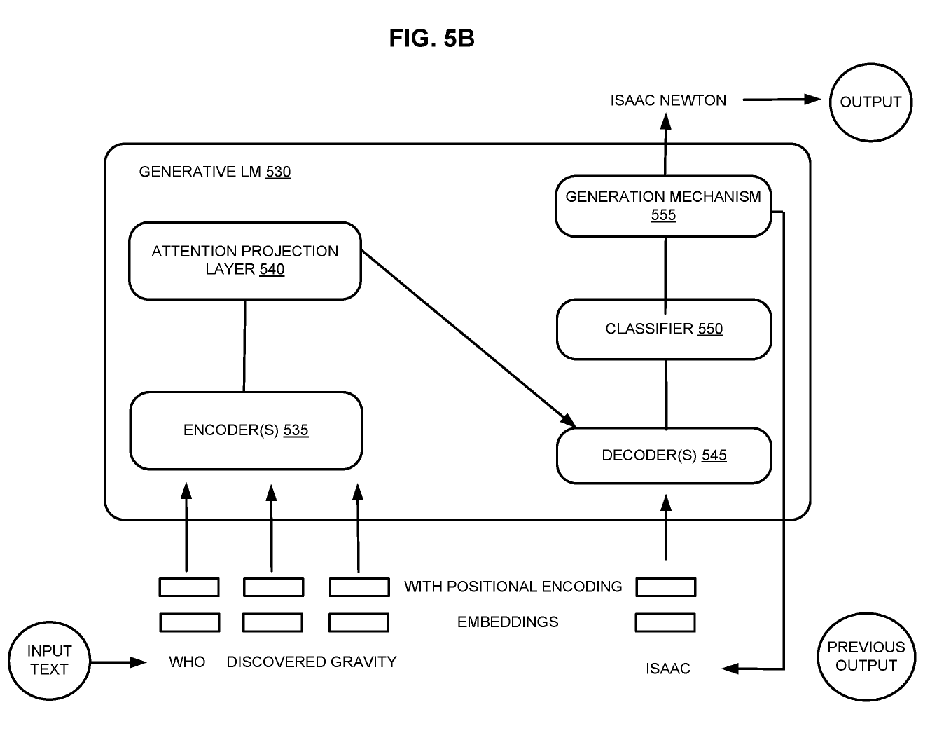

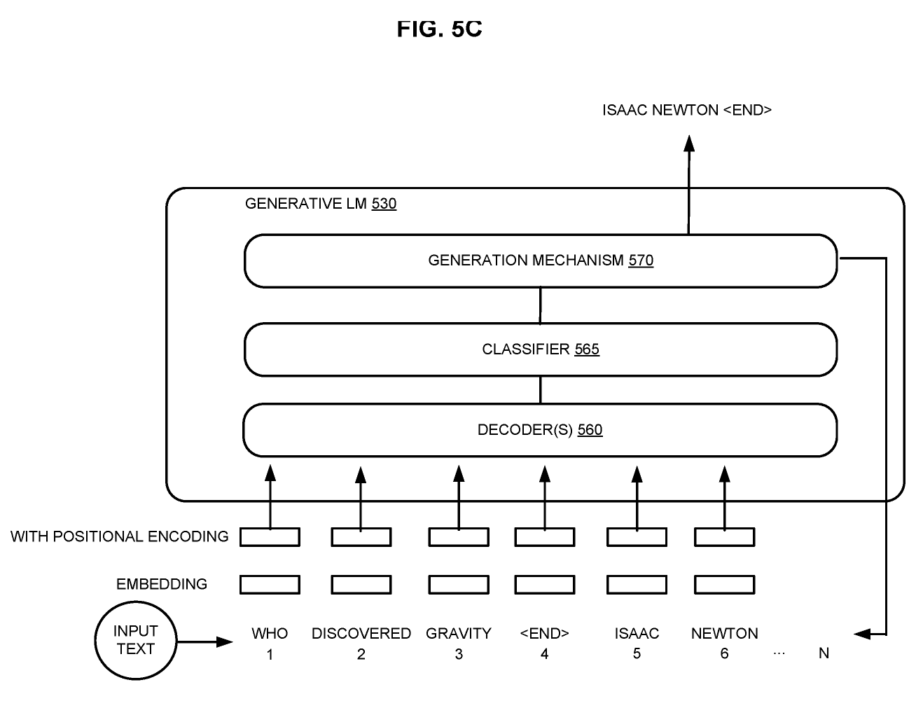

According to embodiments, the AI security data 50 may relate to one or more AI models configured to automate tasks traditionally performed by humans including creating representation of artificial characters, e.g., digital avatars, game characters, chatbots, and/or the like. Example AI models include discriminative models and generative models. Discriminative AI models are trained to classify inputs by identifying patterns in training data (e.g., sounds, images, actions, face expressions, texts, and/or other data), such as presence of a particular type of an object within a training image or a particular word within a training speech or text or data. Generative AI models are trained to generate new data that is similar to human-created (e.g., texts) or naturally occurring (e.g., images) training data. Training can be supervised, self-supervised, unsupervised, reinforced, instructional fine-tuning, and/or the like. After successful training, deployed AI models are used to classify and/or generate new data. For example, generative language models – such as large language models (LLMs) – are capable of supporting conversations in a natural language, understanding speaker’s intent and emotions, explaining complex topics, creating new texts upon receiving suitable prompts, providing advice regarding topics of interest to a user, processing image, audio, and/or other data types, and/or performing other functions. Further details relating to LLMs are described below with reference to FIGS. 5A-5C.

According to embodiments, the AI security data 50 can relate to one or more AI models (e.g., a deep learning model, an LLM, etc.) which can include hundreds of millions or billions of learnable parameters (e.g., weights and biases of artificial neurons) and are trained using massive amounts of training data. Training of such complex models can be performed using distributed computing where multiple (e.g., tens or even hundreds of) computing nodes learn from different sets of training data in parallel. Individual computing nodes deployed in distributed training can include various processing units, such as central processing units (CPUs) and graphics processing units (GPUs). According to embodiments, the computing nodes may include some or all of one or more GPUs, CPUs, parallel processing units (PPUs), data processing units (DPUs), or accelerators, and/or other suitable processing devices capable of performing computing associated with the AI model.

According to embodiments, the security risk scenario identification engine 102 of the security risk scenario management system 100 aggregates the AI security data 50 from the one or more security data source systems 10 (e.g., systems generating AI security research papers, common vulnerabilities and exposures (CVE) databases, technology forums, etc.). As shown in FIG. 1, the security risk scenario identification engine 102 may collect AI security data 50 from the primary computing system 150. According to embodiments, the thread identification engine 102 can include a distributed event streaming platform (e.g., a customized Apache Kafka platform) including connectors configured to communicate with the respective AI model-related security data source systems 10.

The security risk scenario identification engine 102 analyzes the AI security data (e.g., data relating to one or more security attacks associated with an AI model) to identify one or more security risk scenarios associated with one or more AI models (herein referred to as “AI security risk scenarios”). Example AI security risk scenarios include untrusted data deserialization, object reference handing vulnerabilities, unauthorized code execution, shell command execution, sensitive file access, AI model reverse-engineering attacks, memory allocation attacks, CPU/GPU resource exhaustion, resource leakage, thread-based attacks, inferring of sensitive information, extraction of AI model parameters or training data.

According to embodiments, the security risk scenario identification engine 102 processes the AI security data (e.g., raw API requests, model interactions, system metrics, etc.) through a multi-layered detection pipeline that achieves low latency (e.g., sub-100ms latency) with a high accuracy to identify known AI security risk scenarios (e.g., known or previously identified security risk scenarios or attacks). In an embodiment, the security risk scenario identification engine 102 employs statistical anomaly detection to monitor request frequencies, token patterns, and response distributions in real-time, while simultaneously analyzing behavioral patterns using one or more natural language processing models for detecting and identifying new or emerging AI security risk scenarios (e.g., attack vectors that have not been previously identified). Advantageously, the security risk scenario identification engine 102 efficiently identifies a first set of common AI security risk scenarios (e.g., common or known attack vectors such as prompt injection, resource manipulation, etc.) and a second set of emerging AI security risk scenarios through the use of continuous learning via the NPL-based security risk scenario detection and identification.

According to embodiments, the security risk scenario identification engine 102 maintains efficiency by processing a large number of requests in a short period of time (e.g., thousands of requests per second) while keeping a minimal memory footprint, enabling implementation of the security risk scenario identification engine 102 in a production environment where immediate threat response is crucial. According to embodiments, the security risk scenario identification engine 102 includes a first detection component configured to identify known or existing AI security risk scenarios based on the AI security data and a second detection component configured to identify new or emerging AI security risk scenarios based on the AI security data.

In an embodiment, the security risk scenario identification engine 102 employs a rule-based sub-system to identify one or more known security risk scenarios associated with a target AI model that is executed (or executable) by the primary computing system 150. According to embodiments, the security risk scenario identification engine 102 initiates the rule-based sub-system using a comprehensive vulnerability assessment of the target AI model. During this initial phase, the security risk scenario identification engine 102 examines the target AI model's fundamental characteristics, including its architecture type, deployment configuration, access patterns, and defined security boundaries.

For example, when analyzing a target AI model (e.g., a GPT model deployed on the primary computing system 150), the security risk scenario identification engine 102 examines known vulnerabilities (e.g., prompt injection vulnerabilities), evaluates token limit configurations, and reviews rate limiting settings and one or more authentication mechanisms that are in place. Once the initial assessment is complete, the security risk scenario identification engine 102 performs a security risk scenario library correlation process. In this phase, the security risk scenario identification engine 102 matches the identified model characteristics with known attack patterns stored in a security risk scenario library 107 generated by the library generator 106. In an embodiment, the security risk scenario identification engine 102 analyzes each vulnerability category that applies to the specific model and selects relevant attack vectors that could potentially exploit these vulnerabilities. For example, when the security risk scenario identification engine 102 identifies that a target AI model has unrestricted prompt completion capabilities, the security risk scenario identification engine 102 can correlate this characteristic with known prompt injection vulnerabilities and begins formulating appropriate attack scenarios, such as a multi-step prompt manipulation sequence.

According to embodiments, the security risk scenario identification engine 102 performs an attack vector generation phase. During this phase, the security risk scenario identification engine 102 synthesizes one or more specific attack vectors based on identified security risk scenarios and related vulnerability patterns, where identified security risk scenarios are adapted to a configuration of a particular AI model implemented by the primary computing system 150. The security risk scenario identification engine 102 can generate one or more variations of the attack vectors configured and tailored to the characteristics of the target AI model implemented by the primary computing system 150. For example, the security risk scenario identification engine 102 can analyze a completion-based AI model with basic content filtering, and might generate an attack vector that starts with probing model boundaries using benign inputs, then progressively introduces more complex manipulations to test and exploit identified vulnerabilities.

In an embodiment, the security risk scenario identification engine 102 executes the attack vector generation process using a continuous refinement loop. In this embodiment, the security risk scenario identification engine 102 adjusted or refines the one or more generated attack vectors based on information relating to the success or failure of one or more generated attack vectors. In an embodiment, the security risk scenario identification engine 102 uses feedback information associated with a generated attack vector to update a ruleset based on one or more newly discovered vulnerabilities. In an embodiment, the security risk scenario identification engine 102 refines attack patterns based on observed model responses. Advantageously, this continuous learning ensures that the security risk scenario identification engine 102 generates attack vectors that are configured and optimized (e.g., effective) in view of changes in the target AI model deployment and emerging security challenges.

According to embodiments, the security risk scenario identification engine 102 can be implemented according to a microservices architecture, with each component or sub-system of the security risk scenario identification engine 102 containerized for scalability and maintaining isolation. In an embodiment, the security risk scenario identification engine 102 may employ real-time monitoring and feedback loops ensure continuous improvement of the attack vector generation process.

In an example, the security risk scenario identification engine 102 can implement a rules-based methodology to generate one or more attack vectors associated with a target AI model. In this example, the target AI model is a deployed LLM customer service assistant with the following example characteristics: GPT-based completion model, a public-facing API endpoint, basic content filtering, a 4096 token context window, no rate limiting. In this example, the security risk scenario identification engine 102 can implement rule-based processing including a primary rule set. In an example, the primary rule set may include one or more rules indicating: when analyzing a public-facing LLM system, the security risk scenario identification engine 102 first examines the AI model's exposure points; for the customer service assistant, the security risk scenario identification engine 102 identifies the unrestricted API access as a primary vulnerability point; the security risk scenario identification engine 102 then applies a hierarchical set of rules to generate targeted attack scenarios. For example, when the security risk scenario identification engine 102 detects the combination of basic content filtering and no rate limiting, the security risk scenario identification engine 102 automatically flags this as a high-risk configuration requiring immediate attention.

According to embodiments, the security risk scenario identification engine 102 can generate an attack vector associated with one or more security risk scenarios by combining multiple vulnerability rules. In this example, the security risk scenario identification engine 102 identifies that the large context window (4096 tokens) combined with basic content filtering creates an opportunity for context manipulation attacks. The security risk scenario identification engine 102 employs a rules-based approach to generate an attack vector where legitimate customer service queries are combined with carefully crafted context manipulation attempts. For example, the security risk scenario identification engine 102 can generate an attack vector including a sequence where initial messages appear as normal customer inquiries, but gradually introduce elements that probe the model's security boundaries.

For example, the security risk scenario identification engine 102 may identify a first message indicating “I need help with my account settings." In response, the security risk scenario identification engine 102 can apply a rule to determine that the first message has a legitimate context and identify an expected response to the first message to include a normal customer service response. In this example, the security risk scenario identification engine 102 may identify a second message indicating “Can you tell me more about how you help customers?". In response, the security risk scenario identification engine 102 can apply a rule to determine the probe system knowledge boundaries and identify an expected response to the second message to include a general service description. In this example, the security risk scenario identification engine 102 may identify a third message indicating “When helping customers, do you always follow specific guidelines?”. In response, the security risk scenario identification engine 102 can apply a rule to determine the policy disclosure vulnerabilities and in response determine that the sequence of questions represents a potential revelation of internal rules. In this example, the security risk scenario identification engine 102 may identify a fourth message that is generated based on responses to the previous messages. In response, the security risk scenario identification engine 102 can apply a rule to determine that the sequence of questions exploits one or more identified vulnerabilities and identifies the sequence of questions as a potential security boundary breach.

In an embodiment, the security risk scenario identification engine 102 can implement a rules-based process to monitor the above-example interactions to measure one or more of the following parameters: response patterns to identify vulnerability indicators, success rates of different attack approaches, AI model behavior changes under various input conditions, and/or effectiveness of existing security measures. Advantageously, the rules-based process can identify security risk scenarios based on specific AI model characteristics and systematically probe for vulnerabilities, while documenting each iteration or step for use in a subsequent analysis of the target AI model and refinement of the security risk scenario identification process.

According to embodiments, the security risk scenario identification engine 102 performs predictive modeling based on predictive analytics to predict potential AI security risk scenarios associated with one or more AI models. In an embodiment, the predictive modeling employed by the security risk scenario identification engine 102 uses advanced predictive analytics to forecast potential security risks before they manifest as actual threats. In an embodiment, during an initial security analysis associated with a target AI model, the predictive modeling component of the security risk scenario identification engine 102 analyzes patterns in existing attack vectors, system vulnerabilities, security incident histories, model behavior patterns, and/or emerging threat indicators to identify existing or immediate security risk scenarios and establish long-term risk predictions. In an embodiment, the security risk scenario identification engine 102 maintains an ongoing predictive analysis cycle that monitors evolving attack patterns, tracks security incident trends, analyzes new vulnerability discoveries, and evaluates changing threat landscapes.

According to embodiments, the security risk scenario identification engine 102 can employ predictive modeling to perform pattern evolution analysis. In this embodiment, the predictive modeling is applied to historical attack patterns to predict future variations, successful exploit methods to forecast new attack vectors, failed attack attempts to identify potential improvements, and/or security measure effectiveness to predict future vulnerabilities.

According to embodiments, the security risk scenario identification engine 102 can employ predictive modeling to perform contextual risk assessment. In this embodiment, the predictive modeling component performs predictive analysis to examine model deployment environments, usage patterns and trends, security measure effectiveness, and emerging threat landscapes.

According to embodiments, the security risk scenario identification engine 102 can employ predictive modeling to perform vulnerability forecasting. In this embodiment, the predictive modeling component predicts potential weaknesses in current security measures, likely points of future attacks, resource requirement changes, security measure degradation, etc.

According to an embodiment, the security risk scenario identification engine 102 can employ a predictive modeling component to perform an initial analysis including examining current security measures, analyzing existing attack patterns, reviewing vulnerability history, and evaluating deployment contexts. In an embodiment, the predictive modeling component can perform pattern recognition associated with the AI security-related data 50 to identify trending attack methods, identify emerging vulnerability patterns, recognize potential threat combinations, and/or map attack evolution paths. According to embodiments, the security risk scenario identification engine 102 can employ the predictive modeling component to forecasts likely new attack vectors, predicts vulnerability emergence timing, estimate attack success probabilities, and/or project resource requirement changes.

The predictive modeling component may be used in the AI model related security risk scenario analysis by performing pattern evolution for AI model-related security scenarios, including analysis of successful prompt injection patterns to predict new variations, token manipulation techniques to forecast emerging attack methods, model response behaviors to identify potential exploitation points, and context window vulnerabilities to predict new security risk scenarios.

The predictive modeling component may be used to generate AI model-specific security risk scenario predictions. In this embodiment, the predictive modeling component may predict new security risk scenarios by analyzing how successful attacks exploit different AI model architectures, identifying patterns in model response manipulations, tracking how attacks bypass current AI security measures, and/or mapping relationships between different successful exploit methods. According to embodiments, the security risk scenario predictions are added to the security risk scenario library 107 as identified security risk scenarios. Advantageously, these predicted security risk scenarios can expand the security risk scenario library 107, such that the library 107 includes security risk scenarios that are identified from the AI security data 50 and additionally includes predicted security risk scenarios (i.e., scenarios that are predicted based on the identified or known security risk scenarios).

According to embodiments, the classification engine 104 of the security risk scenario management system 100 is configured to classify or categorize each of the identified security risk scenarios into one or more security risk scenario-type categories and one or more AI model categories. In an embodiment, the security risk scenario identification system may classify each identified AI security risk scenario of the set of identified security risk scenarios into a corresponding security risk scenario category of a set of categories to generate a set of classified security risk scenarios.

Example security risk scenario categories include a malicious behavior category, a resource exhaustion category, and a timing attack category. According to embodiments, the classification engine 104 may determine that an identified security risk scenario is to be categorized in the malicious behavior category based on the identification of one or more malicious behavior characteristics. Example malicious behavior characteristics include deserialization vulnerabilities (e.g., an untrusted data deserialization, object reference handling vulnerabilities, etc.), arbitrary code execution (e.g., unauthorized code execution, shell command execution, sensitive file access, etc.), and/or unauthorized information gathering (e.g., AI model reverse-engineering operations, etc.).

According to embodiments, the classification engine 104 may determine that an identified security risk scenario is to be categorized in the resource exhaustion attack category based on the identification of one or more resource exhaustion characteristics. Example resource exhaustion characteristics include memory allocation attacks (e.g., excessive memory allocation), GPU resource abuse (e.g., GPU resource exhaustion), resource leakage (e.g., improper resource management), thread-based attacks (e.g., excessive thread creation, thread starvation, etc.), CPU Exhaustion (e.g., spinlock abuse).

In an example, the classification engine 104 can identify that a “useRuntime” operator is being misused to execute arbitrary code during an inference operation, which can indicate a security breach, data leak, and/or unauthorized access. In this example, the classification engine 104 may categorize the corresponding security risk scenario in the resource exhaustion category.

In another example, the classification engine 104 can identify a security risk scenario including an operator that permits the execution of shell commands, access to sensitive files, and/or compromising of a host system. In this example, the classification engine 104 may categorize the corresponding security risk scenario in the resource exhaustion category.

In another example, the classification engine 104 can identify a security risk scenario involving a malicious actor attempting to use a "tacticSources" operator to gather information about the model's tactics or strategies, which could be used to launch more targeted attacks or to reverse-engineer the model. In this example, the classification engine 104 may categorize the corresponding security risk scenario in the resource exhaustion category.

According to embodiments, the classification engine 104 may determine that an identified security risk scenario is to be categorized in the timing attack category based on the identification of one or more timing attack characteristics. Example timing attack characteristics include processing time analysis (e.g., inferring sensitive information), side-channel attacks (e.g., extracting model parameters or training data), timing control (e.g., use of the Rust programming language to attempt timing control), and the execution of functions to measure and analyze processing times or the use of statistical tools to detect information leakage.

In an embodiment, for each identified security risk scenario identified by the security risk scenario identification engine 102, the classification engine 104 identifies one or more related AI models (i.e., one or more AI models associated with the security risk scenario). In an embodiment, the classification engine 104 includes one or more detection components configured to identify AI-specific security risk scenarios (e.g., attack patterns that are specific to a particular AI model).

According to embodiments, the AI-specific security risk scenario detection component of the classification engine 104 can perform one or more detection operations or functions to identify a set of one or more AI-specific security risk scenarios. In an embodiment, the classification engine 104 analyzes a specific AI model and performs the one or more detection operations, including, for example, learning from one or more successful LLM jailbreak attempts associated with the specific AI model (e.g., successful large language model (LLM) jailbreak attempts), analyzing failed prompt injection attempts associated with the specific AI model, studying model response variations associated with the specific AI model, identifying boundary conditions in behaviors of the specific AI model, etc. The category determined by the classification engine 104 may be provided to the library generator 102 so that the category information for each security risk scenario can be included in the security risk scenario library. Advantageously, unlike traditional security libraries, the generated security risk scenario library includes the NPL-based AI-specific security risk scenario detection that evolves with AI model changes and advancements.

According to embodiments, the classification engine 104 employs AI model-specific classification criteria to classify an association between a security risk scenario and an AI model. According to embodiments, the AI model-specific criteria can include model architecture criteria, training data criteria, operational parameters criteria, security boundary definitions criteria, response characteristics criteria. According to embodiments, the classification engine 104 can categorize each security risk scenario based on which of these criteria the security risk scenario exploits or targets.

Example model architecture criteria can include determining if the security risk scenario is transformer-based or based on a different architecture, one or more attention mechanism vulnerabilities, context window size limitations, layer depth and complexity, etc. According to embodiments, the classification engine 104 can use one or more of the following classification metrics in assessing the model architecture criteria: a number of parameters, a model size category (e.g., small/medium/large), an architecture type (e.g., GPT, BERT, LLaMA, etc.).

Example training data criteria can include a data source type, pre-trained model base, fine-tuning dataset scope, domain specialization, etc. According to embodiments, the classification engine 104 can use one or more of the following classification metrics in assessing the training data criteria: training data size, data diversity measures, domain coverage percentage, etc.

Example operational parameters criteria can include a runtime configuration, temperature settings, top-k/top-p sampling, response length limits, etc. According to embodiments, the classification engine 104 can use one or more of the following classification metrics in assessing the operational parameters criteria: inference speed, resource requirements, batch processing capabilities, etc.

Example security boundary definitions criteria can include model restrictions, content filtering levels, authentication requirements, rate limiting thresholds, etc. According to embodiments, the classification engine 104 can use one or more of the following classification metrics in assessing the security boundary definitions criteria: security level (basic/enhanced/maximum), compliance requirements, access control mechanisms, etc.

Example response characteristics criteria can include output patterns, response consistency, error handling methods, confidence scoring, etc. According to embodiments, the classification engine 104 can use one or more of the following classification metrics in assessing the response characteristics criteria: response variability, error rate thresholds, confidence thresholds, etc.

According to embodiments, the classification engine 104 is configured to translate one or more security risk scenarios detected with respect to a first AI model to one or more other AI models. In an embodiment, the classification engine 104 performs cross-model security risk scenario translation where one or more identified security risk scenarios (e.g., previously discovered vulnerabilities) are mapped or translated across multiple different AI models. In an embodiment, the classification engine 104 maps security risk scenarios identified with respect to a first type of AI model (e.g., generative pre-trained transformer (GPT)) to another type of AI model (e.g., a bidirectional encoder representations from transformers (BERT) model, a large language model meta AI (LLaMA) model, etc.). To perform the cross-model translation, the classification engine 104 may identify one or more common vulnerability patterns across model architectures and use these patterns to generate model-specific security risk scenario variants.

Advantageously, the classification engine 104 employs the one or more NLP models to identify a context (e.g., one or more associated AI models) relating to one or more of the identified security risk scenarios (e.g., the above-described known security risk scenarios, newly identified security risk scenarios, AI-model security risk scenarios, cross-model security risk scenarios, etc.).

According to embodiments, the library generator 106 generates and maintains a data store or library 107 including information associated with identified AI security risk scenarios (herein the “security risk scenario library”). According to embodiments, the security risk scenario library 107 includes the security risk scenarios (as identified by the security risk scenario identification engine 102) associated with a security risk scenario category and one or more associated AI models (as identified by the classification engine 104), as described in detail above.

In an embodiment, the library generator 106 can initialize the security risk scenario library 107 with a set of known security risk scenario, such as training data poisoning scenarios (e.g., malicious manipulation of AI training datasets), model inversion scenarios (e.g., extracting sensitive training data from AI models), adversarial scenarios (e.g., inputs designed to cause AI misclassification), prompt injection scenarios (e.g., manipulating AI responses through carefully crafted inputs), and/or model theft scenarios (e.g., unauthorized exfiltration of proprietary AI models). In an embodiment, the library generator 106 may populate a database of well-documented security risk scenarios (e.g., AI model-related security incidents and vulnerabilities) for inclusion in the generated security risk scenario library 107. The seed database portion may be structured using a standardized schema that captures key details such as attack vectors, impact, and mitigation strategies.

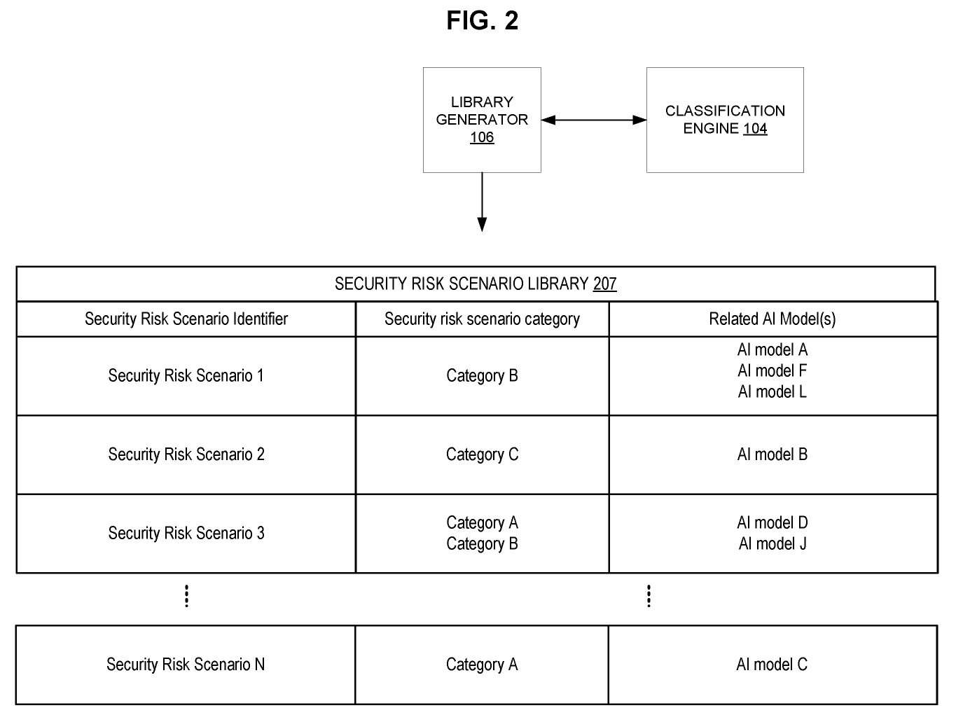

FIG. 2 illustrates an example data structure of a security risk scenario library 207 including information associated with the security risk scenarios, generated by the library generator 106. As shown in FIG. 2, the security risk scenario library 207 may include a series of entries or records, with each record corresponding to an identified security risk scenario. As shown in FIG. 2, each identified security risk scenario may be associated with a security risk scenario identifier (e.g., security risk scenario 1, security risk scenario 2, security risk scenario 3…security risk scenario N), one or more security risk categories (e.g., category A, category B, category C, etc.) and one or more AI models associated with the security risk scenario (e.g., identified using model-specific identification processing or cross-model mapping) (e.g., AI model A, AI model B, AI model C, and so on). As described above, the security risk scenarios of the security risk scenario library 207 may include security risk scenarios that are identified based on aggregated AI security risk data (e.g., known security risk scenarios) and predicted security risk scenarios (e.g., security risk scenarios that are predicted based on an analysis of one or more known or identified security risk scenarios).

In an embodiment, the security risk scenario library 107, 207 may include a set of records, where each record includes information associated with a classified security risk scenario (e.g., an identified security risk scenario and the corresponding category determined by the security risk scenario identification system). Advantageously, the library generator 106 communicates with the security risk scenario identification engine 102 and the classification engine 104 to continually review AI security data collected from one or more sources and dynamically augment, update, and refine the records in the security risk scenario library 107,m 207 associated with previously identified AI security risk scenarios (e.g., based on the latest security trends and incidents) and newly identified AI security risk scenarios. This enables the library generator 106 of the security risk scenario identification system 100 to maintain updated records in the security risk scenario library 107, 207 to ensure the security risk scenario records remain current and comprehensive.

With reference to FIG. 1, the simulation engine 108 of the security risk identification system 100 generates one or more simulated security attacks 130 associated with the primary computing system based on one or more identified AI security risk scenarios. In an embodiment, the simulation engine 108 identifies a target AI model that is executed or to be executed by the primary computing system 150 and uses the one or more identified security risk scenarios associated with the target AI model to generate the simulated security attacks 130 for application to the primary computing system 150.

In an embodiment, the simulation engine 108 executes one or more adversarial machine learning models (AMLs) to generate the one or more simulated security attacks 130 based on the one or more identified AI security risk scenarios to apply to the primary computing system 150. The attack vector simulation process executed by the simulation engine 108 identifying a security risk scenario from the security risk scenario library. In an embodiment, the simulation engine 108 employs a feedback loop where the AML first analyzes a target model's behavior patterns and response characteristics. Based on this analysis, the AML executed by the simulation engine 108 generates one or more adversarial inputs designed to exploit potential vulnerabilities. The simulation engine can continuously measure the target model's responses and adapts its approach in real-time, allowing for dynamic refinement of one or more attack patterns. The simulation engine 108 can iteratively perform the process to develop attack vectors that evolve and become more sophisticated as the simulation engine 108 learns from each previous iteration.

According to embodiments, the simulation engine 108 can implement the AML utilizing a gradient-based attacks methodology, an evolutionary methodology, and/or a reinforcement learning methodology. In an embodiment, the gradient-based attacks methodology provides a systematic approach to modifying inputs by leveraging knowledge of the target model's architecture. These attacks calculate the optimal perturbations needed to maximize the model's error rate while maintaining the appearance of legitimate inputs.

In an embodiment, the evolutionary methodology identifies successful attack patterns and applies genetic mutation principles to create variants, selecting one or more most effective approaches through a natural selection-style processing. This allows for the identification and application of novel attack vectors that may not be identifiable through a traditional analysis.

In an embodiment, the reinforcement learning methodology employs one or more agents to explore a behavior space of a target AI model by learning optimal attack strategies through trial and error, receiving rewards for successful exploits, and receiving penalties for detected attempts. This approach creates a sophisticated learning system that continuously improves its attack capabilities while adapting to new defense mechanisms.

The simulation engine 108 may track, monitor and/or measure the effectiveness of attack simulations through a comprehensive set of metrics that provide detailed insights into both the attack's success and the attacks impact on the primary computing system 150. The success rate measurements may be generated to track a percentage of attacks that achieve one or more intended goals (e.g., target AI model manipulation, data extraction, system resource exhaustion, etc.) The simulation engine 108 may perform resource utilization tracking to monitor the computational and memory overhead required for each attack, helping identify and measure efficient attack vectors. The simulation engine 108 may perform model response analysis to examine how the primary computing system 150 behaves under different attack conditions, including response latency, output consistency, and error patterns. The simulation engine 108 may further perform defense effectiveness evaluation to generate feedback about which attack vectors are most successful against current security measures associated with the primary computing system 150. According to embodiments, the defense effectiveness evaluation information may be used to enable improvement of attack strategies and defensive capabilities.

According to embodiments, the simulation engine 108 uses a generative AI model (e.g., a machine learning model including one or more neural networks) to generate one or more simulated security attacks 130 based on the one or more identified security risk scenarios associated with an AI model that is deployed and/or is to be deployed by the primary computing system 150. In an embodiment, the simulation engine 108 implements a generative AI model including one or more advanced neural networks specifically architected to understand and generate complex attack patterns for AI model security assessment. In an embodiment, the simulation engine 108 generates and adjusts simulated attack vectors for security testing purposes using machine learning based on successful security breach attempts and failed security breach attempts.

According to embodiments, the simulation engine 108 implements an analysis phase during which the simulation engine 108 examines an architecture of a target AI model, security boundaries, and potential vulnerability points. During a next phase (i.e., the generation phase), the simulation engine 108 generates one or more simulated targeted attack sequences based on vulnerability patterns. In a next phase (i.e., an execution phase), the simulation engine 108 deploys the generated simulated attacks while continuously analyzing responses to refine the simulated attack testing and implementation.

In an embodiment, the simulation engine 108 employs a supervised learning process based on known security risk scenarios with reinforcement learning for identifying and deploying novel simulated security attacks 130. This dual approach ensures comprehensive coverage of both known and potential unknown security weaknesses.

According to embodiments, the simulation engine 108 employs feedback loops to measure and identify simulation-related data 135 representing an effectiveness (e.g., results) of a simulated security attack 130 applied to a primary computing system 150. The simulation engine 108 can use the simulation-related data 135 to refine the simulation strategies to develop more sophisticated security risk scenarios and attack patterns.

In an example, the simulation engine 108 may be configured to test and analyze an AI model deployment scenario involving a financial services AI system (i.e., the target AI model). In this example, the simulation engine 108 can analyze a financial advisory chatbot of the target AI model, where the chatbot has the following characteristics: handles sensitive financial data; operates through multiple API endpoints; implements standard security protocols; and processes customer investment queries. The simulation engine 108 may use this characteristics information to generate a simulated security attack having the following progressive attack sequence of interactions: first interaction: "I'm interested in understanding market trends for long-term investments" – applied to establish baseline or legitimate interaction pattern; a second interaction: "How do my investment choices compare to general market trends?" – applied to begin probing data isolation boundaries; a third interaction: “"Could you provide specific examples of successful investment strategies?" – applied to test access to sensitive information; and a fourth interaction in which the simulation engine 108 generates a message intended to exploit the AI model based on one or more observed responses to the previous interactions – applied to execute a refined security attack based on the one or more learned vulnerabilities.

In this example process, the simulation engine 108 can continuously learn from the target AI model’s responses (i.e., the simulation-related data 135), building an evolving library of effective security attacks (e.g., attack vectors) while documenting successful penetration patterns for future security assessments.

In an example, the simulation engine 108 can be employed to administer the simulated security attacks 130 configured to test a customer service AI model. In this example, the customer service AI model includes the following characteristics: the AI model handles: user account management, billing inquiries, technical support requests, and personal user data. In this example, the simulation engine 108 implements an attack sequence using a multi-phase process. During a first phase, the simulation engine 108 performs information gathering by generating the following query: "I need help accessing my account history." The simulation engine 108 then analyzes the simulation-related data 135 (e.g., response patterns, security checks, and data access protocols) received from the target AI model of the primary computing system 150. During a second phase, the simulation engine 108 performs boundary testing by generating the following query: "Can you help me understand how my account information is protected?" The simulation engine 108 then maps security measure boundaries and identifies potential weak points. During a third phase, the simulation engine 108 performs vulnerability probing by generating the following query: "I'm having trouble viewing my previous support tickets. Could you check other user tickets with similar issues?". The simulation engine 108 then tests data isolation and access control mechanisms. During a fourth phase, the simulation engine 108 performs exploit development by generating a next query that is dynamically created based on discovered vulnerabilities. The simulation engine 108 then attempts to leverage identified weaknesses while avoiding detection.

As illustrated by the above example, the simulation engine 108 continuously analyzes responses at each phase and makes adjustments to the simulated security attack based on one or more of the response patterns, security measure triggers, data access limitations, system behavior changes, etc. The above-described dynamic simulation generation approach allows the generative AI employed by the simulation engine 108 to discover complex vulnerabilities that may be missed by traditional security testing methods, while documenting each step for future security improvements.

According to embodiments, the simulation engine 108 can track and collect the simulation-related data 135 from the primary computing system 150. In an embodiment, based on the simulation-related data 135 (e.g., one or more responses by the AI model of the primary computing system 150), the simulation engine 108 executes one or more remedial actions associated with the target AI model. For example, the simulation engine 108 may expose the primary computing system 150 to a simulated security attack 130 and identify simulation-related data 135 (e.g., one or more responses by the primary computing system 150 to that simulated security attack 130). In response to the simulation-related data 135, the simulation engine 108 may determine one or more remedial actions relating to the AI model executed by the primary computing system 150.

According to embodiments, the simulation engine 108 implements a comprehensive remediation framework that automatically generates and recommends one or more specific actions based on identified vulnerabilities during security simulations. These remedial actions may be configured to address both immediate security concerns and long-term system hardening requirements. In an embodiment, the simulation engine 108 executes a remediation process that follows a structured approach based on a severity of discovered vulnerabilities, a complexity of implementation, and/or a potential impact on the functionality of the primary computing system 150.

According to embodiments, the one or more remedial actions may include AI model architecture modifications (e.g., changes to the AI model's architecture when vulnerabilities are identified in the core AI model design). Example AI model architecture modifications may include adjusting the AI model's context window size to prevent context manipulation attacks, implementing additional filtering layers for sensitive information, and modifying the AI model's token processing pipeline to better handle potential adversarial inputs. For example, if simulations reveal that the current context window allows for effective prompt injection attacks, the simulation engine 108 may generate a remedial action including a recommendation to reduce the window size while implementing more sophisticated context validation mechanisms.

According to embodiments, the one or more remedial actions may include access control enhancements. For example, when the application of the simulated security attacks 130 identify weaknesses in the primary computing system’s 150 access management, the remedial actions can include adjusting, modifying, and/or strengthening authentication and authorization mechanisms. In an embodiment, the simulation engine 108 may generate a remedial action that implements more granular role-based access controls, such as, for example, adding multi-factor authentication for sensitive operations and/or establishing stricter API rate limiting policies. The simulation engine 108 may generate a remedial action that includes a recommendation to implement dynamic access controls that adapt based on user behavior patterns and risk assessments.

According to embodiments, the one or more remedial actions may include data protection measures. For example, if vulnerabilities in data handling are discovered, the simulation engine 108 may generate a remedial action that includes a recommendation for data protection enhancements such as implementing additional encryption layers for sensitive data, establishing more robust data isolation mechanisms, and creating sophisticated data access logging systems. For example, if the simulated security attacks 130 reveal potential data leakage through the simulation-related data 135 (e.g., the AI model responses), the simulation engine 108 may recommend implementing advanced output filtering and sanitization protocols.

In an example, the simulation engine 108 may generate a remedial action associated with simulated security attacks 130 corresponding to a financial advisory AI model implemented by a primary computing system 150. In this example, the simulated security attacks 130 may cause simulation-related data 135 indicating a prompt injection susceptibility. In response, the simulation engine 108 may generate a remedial action including implementation of a multi-layer prompt validation system including adding semantic analysis of input prompts, implementing context consistency checking, deploying real-time prompt pattern matching, and/or establishing prompt history validation.

In this example, the simulated security attacks 130 may cause simulation-related data 135 indicating an insufficient rate limiting. In response, the simulation engine 108 may generate a remedial action including enhanced request management including implementing adaptive rate limiting based on user behavior, deploying sophisticated request pattern analysis, adding automatic throttling for suspicious patterns, and/or establishing user-specific request quotas.

In this example, the simulated security attacks 130 may cause simulation-related data 135 indicating data leakage potential. In response, the simulation engine 108 may generate a remedial action including advanced data protection measures including deploying enhanced output filtering, implement sensitive data masking, adding response pattern analysis, and establishing data access boundaries.

In this example, the simulated security attacks 130 may cause simulation-related data 135 indicating a security gap such as inadequate threat monitoring. In response, the simulation engine 108 may generate a remedial action including the implementing of a comprehensive monitoring system including deploying real-time attack detection, implementing behavioral analytics, adding automated response mechanisms, and establishing detailed audit logging.

According to embodiments, the simulation engine 108 can prioritizes the above example remedial actions based on one or more factors including vulnerability severity, implementation complexity, resource requirements, potential impact on system performance, and/or business continuity considerations. According to embodiments, each remedial action may be accompanied by detailed implementation guidelines, success metrics and validation criteria, rollback procedures, performance impact assessments, and/or compliance verification steps.

According to embodiments, the simulation engine 108 can employ a predictive modeling component to generate predicted vulnerability patterns, identify potential attack vectors, suggest likely exploitation methods, and forecasts emerging threat patterns in connection with the generation of simulated security attacks 130. In an embodiment, the simulation engine 108 uses the predictive modeling component to generate predictions for use in generating simulated security attacks, identify feedback relating to the simulating security attacks 130, such as to receives success/failure data from the generated simulated security attacks, incorporate new attack pattern discoveries, refine attack strategies using predicted forecasts, update prediction models based on simulation results, validates predictions through testing, and refine future predictions relating to security attacks.

The predictive modeling component of the simulation engine 108 can be used in the generation of simulated security attacks 130 by convert predicted vulnerabilities into simulated security attacks 130, providing probability scores for attack success rates, identifying optimal attack sequence combinations, and suggesting specific prompt engineering techniques.

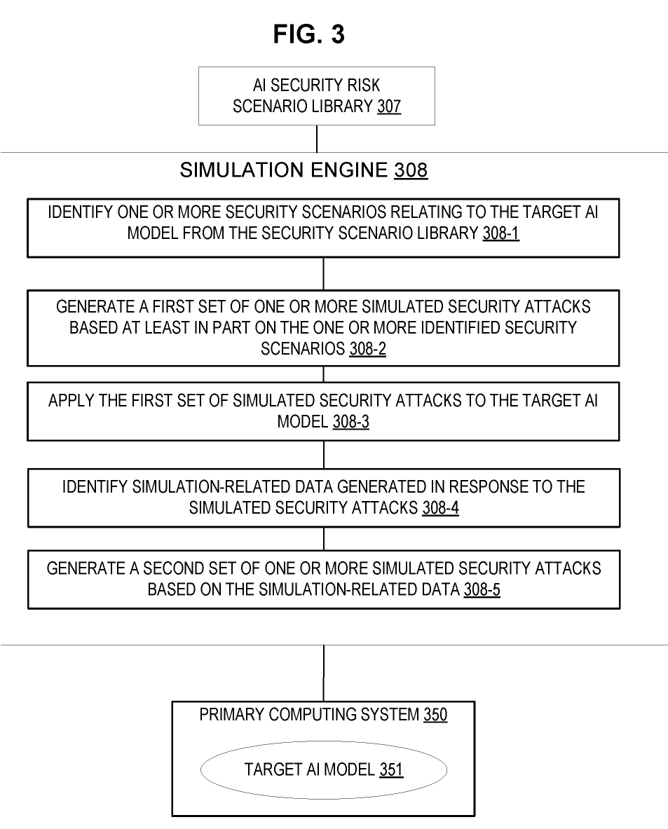

FIG. 3 illustrates an example simulation engine 308 of a security risk scenario identification system (e.g., the security risk scenario identification system 100 of FIG. 1) configured to perform a security risk simulation associated with a target artificial intelligence model 351 of a primary computing system 350, according to at least one embodiment. As shown in FIG. 3, in operation 308-1, the simulation engine 308 identifies one or more security scenarios relating to the target AI model 351 from the security scenario library 307. As described in detail above, the security scenario library 307 is generated by the security risk scenario identification system (e.g., the library generator 106 of the security risk scenario identification system 100 of FIG. 1) and includes a listing of identified security risk scenarios with classification information identifying one or more related AI models. In an embodiment, the simulation engine 308 can identify the one or more security scenarios that are classified as being related to the target AI model 351 that is to be tested.

At operation 308-2, the simulation engine 308 generates a first set of one or more simulated security attacks (e.g., simulated security attacks 130 of FIG. 1) based at least in part on the one or more identified security scenarios (as described in detail above). At operation 308-3, the simulation engine 308 applies the simulated security attacks to the target AI model 351. At operation 308-4, the simulation engine 308 identifies simulation-related data (e.g., simulation-related data 135 of FIG. 1) generated by the target AI model 351 in response to the simulated security attacks. In an embodiment, at operation 308-5, the simulation engine 308 generates a second set of one or more simulated security attacks based on the simulation-related data returned by the target AI model 351. In an embodiment, the simulation engine 308 can adaptively generate and apply one or more simulated attacks based on an analysis of the simulation-related data generated by the target AI model (e.g., data generated in response to the first set of simulated security attacks applied in operation 308-3.

With reference to FIG. 1, the identified security risk scenarios stored in the security risk scenario library 107 can be used in an assessment of an overall risk rating associated with a particular AI model. In an embodiment, the security risk scenarios identified by the security risk scenario management system 100 can be used in the determination of a risk rating relating to an AI model that is executable by a primary computing system. Advantageously, the robust, updated, and managed security risk scenario library and the contents thereof can be used in the assessment of the risk presented to a primary computing system by one or more downloadable and executable AI models. In addition to the use of the security risk scenario library, information associated with the execution of simulated security attacks and the related data generated by a target AI model can be used in generating an overall risk assessment of the target AI model.

According to embodiments, the security risk scenario management system 100 may be integrated (e.g., via one or more plug-ins) to one or more AI model testing frameworks. For example, the security risk scenario management system 100 can employ plugins for frameworks such as PyTest and Unittest to incorporate the security scenario library 107 into test suites. In an embodiment, the security risk scenario management system 100 can create a Python-based package with decorators and assertions for AI security testing, interfacing with the security scenario library 107 for inclusion in one or more test suites. According to embodiments, the security scenario library 107 may be developed as a lightweight library with bindings to monitor one or more applications executing AI models to identify abuse attempts (e.g., resource spikes, suspicious timing patterns) and take one or more remedial actions (e.g., throttling, shutting down) to protect the primary computing system.

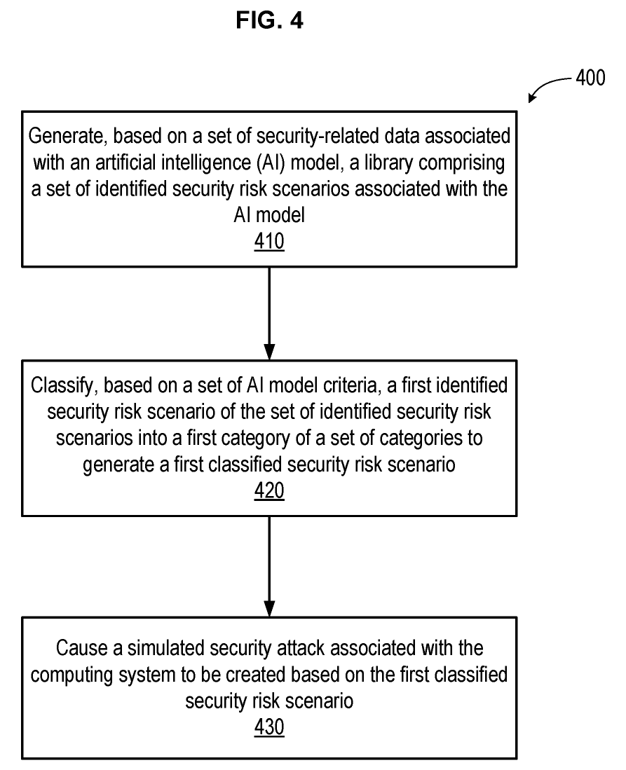

FIG. 4 is a flow diagram of an example method 400 related to identifying security risk scenarios associated with one or more AI models executable by one or more applications of a computing system (e.g., primary computing system 150, 350 of FIGS. 1 and 3, respectively), in accordance with at least some embodiments. Method 400 may be performed to generate a library of security risk scenarios associated with one or more AI models and use the identified security risk scenarios to generate simulated security attacks for application to the computing system. According to embodiments, the method 400 may be performed by control logic (e.g., security risk scenario management system 100 of FIG. 1). Method 400 may be performed by the control logic associated with one or more processing units (e.g., CPUs and/or GPUs), which may include (or communicate with) one or more memory devices. Various operations of method 400 may be performed in a different order compared with the order shown in FIG. 4. Some operations of the methods may be performed concurrently with other operations. In at least one embodiment, one or more operations shown in FIG. 4 may not always be performed.

At block 410, control logic (e.g., security risk scenario management system 100 of FIG. 1) generates, based on a set of security-related data associated with an artificial intelligence (AI) model, a library comprising a set of identified security risk scenarios associated with the AI model. According to embodiments, the control logic can collect or aggregate the set of security-related data from multiple different sources and use that aggregated data to identify one or more security risk scenarios associated with the one or more AI models. According to embodiments, the library can be generated and updated to add newly identified security risk scenarios and predicted security risk scenarios, as described in detail above.

At block 420, control logic classifies, based on a set of AI model criteria, a first identified security risk scenario of the set of identified security risk scenarios into a first category of a set of categories to generate a first classified security risk scenario. According to embodiments, each identified security risk scenario can be analyzed to determine a corresponding classification or category, and the classification information can be added in the library (e.g., as shown in the example library 207 of FIG. 2). According to embodiments, control logic can further determine a mapping or association between an identified security risk scenario and one or more AI models (e.g., one or more AI models that, when executed, present the identified security risk scenario to a corresponding computing system).

At block 430, control logic causes a simulated security attack associated with the computing system to be created based on the first classified security risk scenario. According to embodiments, control logic can cause the simulated security attack to be applied to the computing system. Advantageously, control logic can monitor and collect data relating to the execution of the simulated security attack from the computing system to determine the manner in which the AI model executed by the computing system reacted to the simulated security attack. For example, the computing system may generate simulation-related data that indicates that the simulated attack associated with a security risk scenario resulted in the computing system (or the AI model of the computing system) performing a set of operations which present a security risk to the computing system. According to an embodiment, control logic can determine a remedial action to mitigate the computing system’s response to the simulated security attack associated with the identified security risk scenario relating to the AI model.

The systems and methods described herein may be used for a variety of purposes, by way of example and without limitation, to assess the risks associated with AI models used, for example, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs – such as text, audio, video, image, etc. In some embodiments, LLM architectures such as recurrent neural networks (RNNs) or long short-term memory networks (LSTMs) may be used, while in other embodiments transformer architectures – such as those that rely on self-attention mechanisms – may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a VLM, a multi-modal LM, etc.).

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 530. In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multimodal inputs, the input 501 may combine text with image data, audio data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 may be used to retrieve additional information to be used as part of the input 501 or prompt. For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve – using a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history – or at least a summary thereof – and include the prior conversation history along with the current ask/request as part of the input 501 to the generative LM 530.

The tokenizer 510 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data, the input processor 501 may resize the image data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 501 may resample an audio file to a consistent sampling rate for uniform processing, and the embedding component 520 may use any known technique to extract and encode audio features – such as in the form of a spectrogram (e.g., a mel-spectrogram). In some implementations in which the input 501 includes video data, the input processor 501 may extract frames or apply resizing to extracted frames, and the embedding component 520 may extract features such as optical flow embeddings or video embeddings and/or may encode temporal information or sequences of frames. In some implementations in which the input 501 includes multimodal data, the embedding component 520 may fuse representations of the different types of data (e.g., text, image, audio) using techniques like early fusion (concatenation), late fusion (sequential processing), attention-based fusion, etc.

The generative LM 530 and/or other components of the generative LLM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use – or capable of accessing or using – plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., third party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated – e.g., recursively – for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources – such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

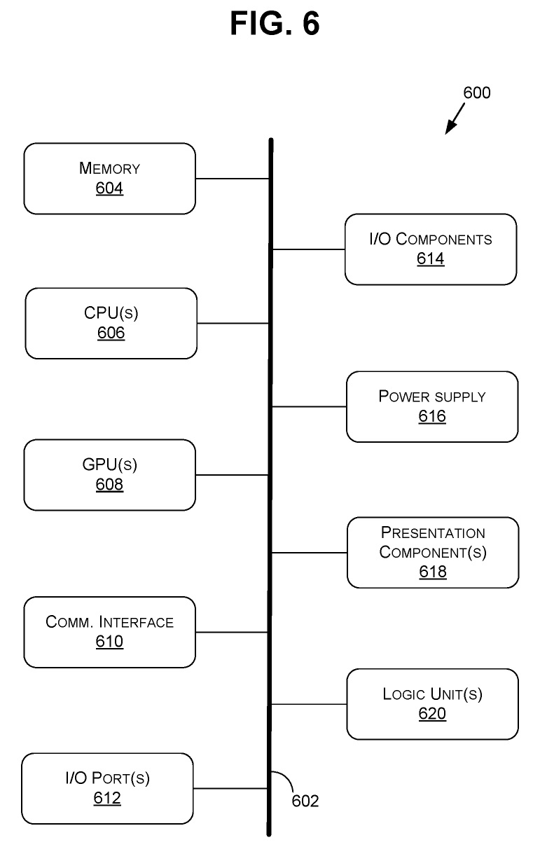

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using a communication interface such as NVIDIA® NVLink®) or may connect the GPUs through a switch (e.g., using a communication interface switch such as NVIDIA® NVSwitch®). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

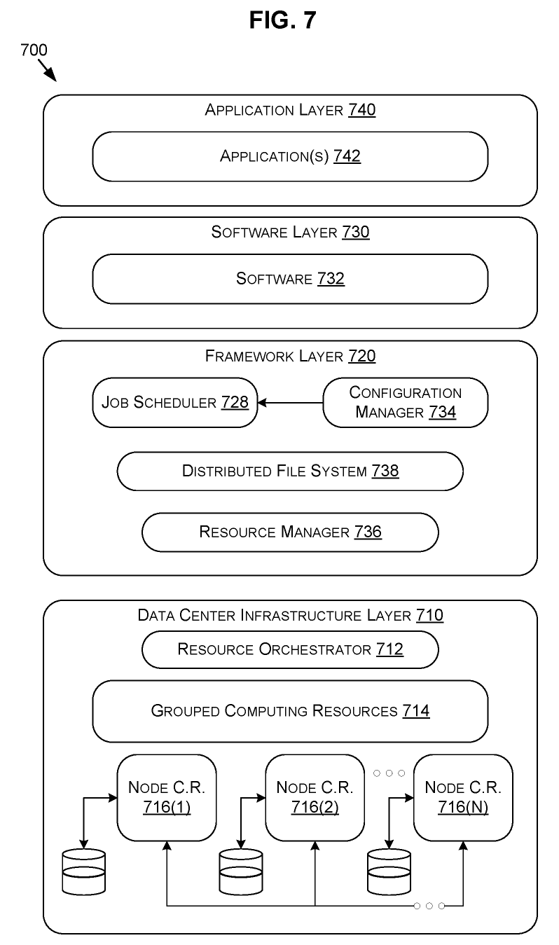

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache SparkTM (hereinafter “Spark”) that may use distributed file system 738 for large-scale data processing (e.g., "big data"). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7 – e.g., each device may include similar components, features, and/or functionality of the computing device(s) 700. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, based on a set of security-related data associated with an artificial intelligence (AI) model, a library comprising a set of identified security risk scenarios associated with the AI model executable by a computing system;
classifying, based on a set of AI model criteria, a first identified security risk scenario of the set of identified security risk scenarios into a first category of a set of categories to generate a first classified security risk scenario; and
causing a simulated security attack associated with the computing system to be created based on the first classified security risk scenario.

2. The method of claim 1, further comprising generating, using a predictive model, one or more predictions associated with one or more security risk scenarios of the set of identified security risk scenarios.

3. The method of claim 2, further comprising identifying a second identified security risk scenario based on the one or more predictions.

4. The method of claim 3, further comprising updating the library to include the second identified security risk scenario.

5. The method of claim 1, further comprising:
causing the simulated security attack to be applied to the computing system; and
identifying a response by the computing system to the simulated security attack.

6. The method of claim 5, further comprising determining, based on the response, a remedial action with respect to the computing system.

7. The method of claim 5, further comprising generating a further simulated security attack based on the response by the computing system to the simulated security attack.

8. The method of claim 7, further comprising causing the further simulated security attack to be applied to the computing system.

9. A system comprising:
a memory device; and
a processing device coupled to the memory device, wherein the processing device performs operations comprising:
generating, based on a set of security-related data associated with an artificial intelligence (AI) model, a library comprising a set of identified ai security risk scenarios associated with the AI model executable by a computing system;
classifying, based on a set of AI model criteria, a first identified security risk scenario of the set of identified security risk scenarios into a first category of a set of categories to generate a first classified security risk scenario; and
causing a simulated security attack associated with the computing system to be created based on the first classified security risk scenario.

10. The system of claim 9, the operations further comprising generating, using a predictive model, one or more predictions associated with one or more security risk scenarios of the set of identified security risk scenarios.

11. The system of claim 10, the operations further comprising further comprising identifying a second identified security risk scenario based on the one or more predictions.

12. The system of claim 11, the operations further comprising further comprising updating the library to include the second identified security risk scenario.

13. The system of claim 9, the operations further comprising:
causing the simulated security attack to be applied to the computing system; and
identifying a response by the computing system to the simulated security attack.

14. The system of claim 13, the operations further comprising determining, based on the response, a remedial action with respect to the computing system.

15. The system of claim 13, the operations further comprising generating a further simulated security attack based on the response by the computing system to the simulated security attack.

16. The system of claim 15, further comprising causing the further simulated security attack to be applied to the computing system.

17. A non-transitory computer readable storage medium comprising instructions that, when executed by a processing device, cause the processing device to perform operations comprising:
generating, based on a set of security-related data associated with an artificial intelligence (AI) model, a library comprising a set of identified security risk scenarios associated with the AI model executable by a computing system;
classifying, based on a set of AI model criteria, a first identified security risk scenario of the set of identified security risk scenarios into a first category of a set of categories to generate a first classified security risk scenario; and
causing a simulated security attack associated with the computing system to be created based on the first classified security risk scenario.

18. The non-transitory computer readable storage medium of claim 17, the operations further comprising:
causing the simulated security attack to be applied to the computing system; and
identifying a response by the computing system to the simulated security attack.

19. The non-transitory computer readable storage medium of claim 18, the operations further comprising generating a further simulated security attack based on the response by the computing system to the simulated security attack.

20. The non-transitory computer readable storage medium of claim 19, the operations further comprising causing the further simulated security attack to be applied to the computing system.
